(19) United States
(12) Patent Application Publication
(10) Pub. No.: US 2026/0218741 A1
(43) Pub. Date: Jul. 30, 2026

(54) CONNECTION DEVICE AND ROBOT ARM

(71) Applicant: KUKA Deutschland GmbH, Augsburg (DE)

(72) Inventors: Martin Riedel, Augsburg (DE); Tom Clauder, Augsburg (DE)

(73) Assignee: KUKA Deutschland GmbH, Augsburg (DE)

(21) Appl. No.: 19/141,803

(22) PCT Filed: Nov. 15, 2023
(86) PCT No.: PCT/EP2023/081810

§ 371 Date: Jun. 20, 2025

(30) Foreign Application Priority Data
Dec. 23, 2022 (DE) 10 2022 134 703.6

(51) Int. Cl. F16B 7/18; B25J 17/00

(52) U.S. Cl. CPC F16B 7/182; B25J 17/00

(57) ABSTRACT

A connection device for connecting a link of a robot arm to a joint body of the robot arm includes a connection ring connected to an outer cladding wall of a link and which has a plurality of receiving areas distributed uniformly over the circumference. Each receiving area is designed to receive an engagement element of a joint support ring in a form-fitting manner to connect the link to the joint body when the connection ring is connected to the joint support ring. The engagement elements of the joint support ring engage in the receiving areas of the connection ring in a form-fitting manner.

### CROSS-REFERENCE TO RELATED APPLICATIONS

This application is a national phase application under 35 U.S.C. § 371 of International Patent Application No. PCT/EP2023/081810, filed Nov. 15, 2023 (pending), which claims the benefit of priority to German Patent Application No. DE 10 2022 134 703.6, filed Dec. 23, 2022, the disclosures of which are incorporated by reference herein in their entirety.

### TECHNICAL FIELD

The invention relates to a connection device for connecting a link of a robot arm to a joint body of the robot arm. The invention also relates to an associated robot arm.

### BACKGROUND

WO 2017/207337 A1 describes a joint for an articulated manipulator, comprising a tubular body extending along a longitudinal axis thereof and having a first joint end and a second joint end, the first joint end and the second joint end defining a first joint plane and a second joint plane, respectively. The first joint plane and the second joint are each at an inclination angle with respect to the longitudinal axis, the first joint plane being arranged parallel to a first axis, and the second joint plane being arranged parallel to a second axis, the longitudinal axis being perpendicular to the first axis and the second axis, and the first axis and the second axis being at a mutual rotation angle at least one times greater than the inclination angle.

### SUMMARY

The object of the invention is to provide a stable, reliable and resilient connection device for connecting a link of a robot arm to a joint body of the robot arm. A further object is to provide a robot arm having at least one such stable, reliable and resilient connection device.

The object is achieved by a connection device for connecting a link of a robot arm to a joint body of the robot arm, comprising:
a link having a circular cylindrical outer cladding wall,
a joint body having a joint support ring which has a plurality of engagement elements distributed uniformly over the circumference, and
a connection ring which is connected to the outer cladding wall of the link and which has a plurality of receiving areas distributed uniformly over the circumference, each receiving area being designed to receive one of the engagement elements of the joint support ring in a form-fitting manner to connect the link to the joint body when the connection ring is connected to the joint support ring in that the engagement elements of the joint support ring engage in the receiving areas of the connection ring in a form-fitting manner.

For the cost-effective production of robot arms, it can be expedient to construct the plurality of joints of the robot arm identically or at least to construct them from only a few different joint types. In addition, it is expedient if the links are also constructed from simple rod bodies. The simple rod bodies can in particular consist of profile rods which have constant cross sections, in particular over their respective lengths. The cross section can in particular be a circular cross section or a circular tube cross section. This has the advantage that the links can be produced cost-effectively, in particular because they can be easily obtained, for example in the form of semi-finished products, and can be cut to different lengths depending on the desired kinematic design for the robot arm.

The problem with robot arms which are constructed from links having circular cylindrical outer cladding walls and from joints in the form of joint bodies is the connection of a link to an immediately adjacent joint body. All forces and moments occurring during a movement of the robot arm must be reliably transmitted via the relevant connection of the link to the immediately adjacent joint body to ensure the proper function of the robot arm.

The inventive connection device provides a very stable, reliable and resilient connection device for connecting a link of a robot arm to a joint body of the robot arm.

The particular link has a circular cylindrical outer cladding wall. The link in question can accordingly be formed by a circular cylindrical tube or by a circular cylindrical tube portion. By cutting such a tube to length, the desired or required length of the link in question can be produced. The particular length of the tube or tube portion then determines the geometric distance between the two joint bodies directly connected by the link in question and thus the geometric distance between the two directly connected axes of rotation of the robot arm.

The joint body can have a first casing part which is, for example, rotatably mounted with respect to a second casing part of the joint body. The first casing part, in conjunction with the second casing part, forms the joint. The joint body can also have a gear and/or a drive by which the joint can be adjusted automatically. The first casing part and/or the second casing part can have a flange to which the subsequent link of the robot arm is connected. The flange can inventively have or form a joint support ring. The link to be connected can be attached to the joint body or to the relevant casing part of the joint body via the joint support ring.

The joint support ring of the joint body has a plurality of engagement elements distributed uniformly over the circumference. The engagement elements can be located on a common circumferential circle with respect to a center, where the center lies on an axis of symmetry of the joint support ring. The engagement elements can be designed to project and extend parallel to the axis of symmetry of the joint support ring at a distance therefrom, namely away from the joint body, toward the link or toward the connection ring of the link to be connected.

The connection ring is firmly connected to the outer cladding wall of the link. Such a firm connection can be achieved, for example, by gluing. As a result, the link and the connection ring form a composite component as a unit.

The connection ring has a plurality of receiving areas distributed uniformly over the circumference. The receiving areas are each designed to receive one of the engagement elements of the joint support ring in a form-fitting manner. Each receiving area accordingly has a recess into which an engagement element of the joint support ring is inserted and is guided and held flush there.

Through the interengagement of the engagement elements and the receiving areas, the link is connected to the joint body when the connection ring is connected to the joint support ring. Such a connection can in particular be a detachable connection, i.e., the connection ring and the joint support ring can be disconnected from one another again without destruction, optionally using hand tools, such as screwdrivers and/or levers, so that the link in question can be detached from the joint body again. The various links and various joint bodies can then be reassembled, optionally in a modified kinematic configuration. In this way, robot arms of different constructions can be created in a modular manner from a number of identical or different links and a number of identical or different joint bodies.

Each engagement element of the joint support ring can be designed as a claw projecting in the axial insertion direction, which claw has a claw front side pointing in the circumferential direction and a claw rear side pointing opposite to the circumferential direction, the claw front side and the claw rear side being inclined obliquely toward one another in a radially inwardly pointing radial direction on the one hand and also being inclined obliquely toward one another in the axial insertion direction on the other hand, and each receiving area of the connection ring being designed as a pocket corresponding to the claw, which pocket has a pocket front side pointing in the circumferential direction and a pocket rear side pointing opposite to the circumferential direction, the pocket front side and the pocket rear side being inclined obliquely toward one another in a radially inwardly pointing radial direction on the one hand and also being inclined obliquely away from one another in the axial insertion direction on the other hand.

The axial insertion direction is determined by the longitudinal extent of the circular cylindrical link, i.e., by the axis of symmetry of the cylindrical body of the link, in particular a tubular link. The claws lie on a partial circle which runs coaxially around the axis of symmetry. The claws thus project from a base body of the joint body in the direction of the connection ring. The claws project at least substantially parallel to the insertion direction, i.e., parallel to the axis of symmetry of the link.

The claws can be designed in the form of a trapezoidal prism with regard to their external shape.

The particular claw can have a claw front side facing in the circumferential direction, which is a flat surface and is at least substantially rectangular in shape.

In the same sense, the particular claw can have a claw rear side facing opposite to the circumferential direction, which is also a flat surface and is at least substantially rectangular in shape.

In this embodiment, the claw front side and the claw rear side are inclined obliquely toward one another in a radially inwardly pointing radial direction. This means that the particular claw is narrower in the circumferential direction on its radially inner side than on its radially outer side. In other words, the particular claw is less wide radially on the inside in the circumferential direction than radially on the outside.

This also means that the claw front side of one claw forms a pair of wedge surfaces with the claw rear side of an immediately adjacent claw, such that the wedge surfaces on the radially outer side are at a greater distance from one another, i.e., are further apart from one another, than on the radially inner side.

In this embodiment, the claw front side and the claw rear side are also inclined obliquely toward one another in the axial insertion direction. In other words, the foot of the claw is wider in the circumferential direction than the head of the claw. The axial insertion direction here refers to an insertion movement of the joint support ring in the direction toward the connection ring.

This means that in a foot region of the adjacent claws, the claw front side of one claw and the claw rear side of the other claw are closer together than in a head region of the adjacent claws. The claw intermediate space of two adjacent claws therefore opens from the foot toward the head, i.e., in the insertion direction of the claws.

In order to form each receiving area such that it corresponds, i.e., flatly fits, a claw, each receiving area of the connection ring is designed as a pocket corresponding to the claw.

The particular pocket can have a pocket front side facing in the circumferential direction, which is a flat surface and is at least substantially rectangular in shape.

In the same sense, the particular pocket can have a pocket rear side facing opposite to the circumferential direction, which is also a flat surface and is at least substantially rectangular in shape.

In this embodiment, the pocket front side and the pocket rear side are inclined obliquely toward one another in a radially inwardly pointing radial direction. This means that the particular pocket is narrower in the circumferential direction on its radially inner side than on its radially outer side. In other words, the particular pocket is less wide radially on the inside in the circumferential direction than radially on the outside.

This also means that the pocket front side of one pocket forms a pair of wedge surfaces with the pocket rear side of an immediately adjacent pocket, such that the wedge surfaces on the radially outer side are at a greater distance from one another, i.e., are further apart from one another, than on the radially inner side.

In this embodiment, the pocket front side and the pocket rear side are also inclined obliquely away from one another in the axial insertion direction. In other words, the base of the pocket is narrower in the circumferential direction than in the upper edge region of the pocket. The axial insertion direction here refers to an insertion movement of the connection ring in the direction toward the joint support ring.

This means that in an upper edge region of the adjacent pockets, the pocket front side of one pocket and the pocket rear side of the other pocket are closer together than in a base region of the adjacent pockets. A pocket intermediate space opens, i.e., widens starting from the base of the pocket in the direction of the upper edge region of the pocket, i.e., in the insertion direction of the connection ring, in the direction of the joint support ring.

Each claw projecting in the axial insertion direction can have a claw inner side which is designed such that, when the connection ring is connected to the joint support ring, a particular claw inner side of the claw sits precisely on the outer cladding wall of the link. Here too, the axial insertion direction refers to an insertion movement of the joint support ring in the direction of the connection ring. The claw inner side is therefore located on a radial inner side of the claw. The particular claw inner side of the claw should sit precisely directly on the outer cladding wall of the link. For this purpose, the connection ring can have corresponding pockets which do not have pocket walls at the base of the pockets, i.e., on a radially inner side of the pockets, but are designed to be open, so that in this region the outer cladding wall of the link is exposed, i.e., not covered by the connection ring. The claw inner sides of the joint support ring can then rest directly on these exposed portions of the outer cladding wall of the link. Forces and/or moments can thus be transmitted directly to the link via the claw inner sides, without these forces and/or moments having to be guided via the connection ring.

The engagement elements of the joint support ring can engage in the receiving areas of the connection ring in such a way that, when the connection ring is connected to the joint support ring, a particular end wall of each engagement element pointing in the insertion direction is positioned at a distance from associated bottom walls of the corresponding receiving areas of the connection ring, while leaving a corresponding gap.

In that, when the connection ring is connected to the joint support ring, a particular end wall of each engagement element pointing in the insertion direction is positioned at a distance from associated bottom walls of the corresponding receiving areas of the connection ring, while leaving a corresponding gap, it can be ensured that the connections of the engagement elements to the receiving areas are ensured at the lateral wall portions of the engagement elements and the receiving areas. The corresponding gap prevents the head-side end walls of the engagement elements from touching the connection ring. If the engagement elements were to rest with their head-side end walls on the connection ring, it would not be ensured that the lateral wall portions of the engagement elements and the lateral wall portions of the receiving areas would lie flush with one another. Because the lateral wall portions of the engagement elements and the lateral wall portions of the receiving areas lie flush with one another, torques about the link axis, i.e., about the axis of symmetry of the joint support ring or the link, can be transmitted particularly well and reliably.

The engagement elements of the joint support ring can engage in the receiving areas of the connection ring in such a way that, when the connection ring is connected to the joint support ring, a particular front edge protrusion pointing in the insertion direction, which connects two adjacent receiving areas, is positioned at a distance from associated foot walls of the joint support ring, each of which connects two adjacent engagement elements, while leaving a corresponding gap.

In that, when the connection ring is connected to the joint support ring, a particular front edge protrusion pointing in the insertion direction, which connects two adjacent receiving areas, is positioned at a distance from associated foot walls of the joint support ring, each of which connects two adjacent engagement elements, while leaving a corresponding gap, it can be ensured that the connections of the engagement elements to the receiving areas are ensured at the lateral wall portions of the engagement elements and the receiving areas. The corresponding gap prevents the head-side end walls of the connection ring from touching the foot walls of the engagement elements. If the connection ring were to rest with its head-side end walls on the joint support ring, it would not be ensured that the lateral wall portions of the engagement elements and the lateral wall portions of the receiving areas would lie flush with one another. Because the lateral wall portions of the engagement elements and the lateral wall portions of the receiving areas lie flush with one another, torques about the link axis, i.e., about the axis of symmetry of the joint support ring or the link, can be transmitted particularly well and reliably.

Each receiving area can have an arcuate, radially outwardly curved receiving area circumferential outer wall and each engagement element can have a flat engagement element circumferential outer wall, so that when the connection ring is connected to the joint support ring, a gap is formed between the inner side of each receiving area circumferential outer wall and the corresponding outer side of the relevant engagement element circumferential outer wall.

The arcuate, radially outwardly curved receiving area circumferential outer walls of all receiving areas can lie on a common circular cylindrical circumferential surface of the connection ring. Each gap can be designed in the form of a circular cylinder portion, cut parallel to the axis of symmetry of the circular cylinder. The gap prevents forces and/or moments from being transmitted radially outward, circumferentially between the connection ring and the joint support ring at these points between the connection ring and the joint support ring. In particular, the gap prevents undesired shear forces and/or shear stresses from a torque between the connection ring and the joint support ring from being transmitted there. Therefore, the transmission of forces and/or moments remains only at the pocket front sides and the pocket rear sides of the connection ring with respect to the claw front sides and the claw rear sides of the joint support ring. There, the forces are transmitted at least substantially perpendicular to the contact surfaces of the connection ring and the joint support ring.

The connection ring can be glued onto the circular cylindrical outer cladding wall of the link. For this purpose, the connection ring can have an inner cladding wall facing the link. The adhesive can be applied between the inner cladding wall of the connection ring and the circular cylindrical outer cladding wall of the link. The adhesive can be a self-curing adhesive. It can also be a multi-component reactive adhesive.

The connection ring can have an inner cladding wall which forms a contact surface with which the connection ring is glued onto the circular cylindrical outer cladding wall of the link, the inner cladding wall being provided with longitudinal grooves which form distribution channels for an adhesive by means of which the connection ring is glued onto the circular cylindrical outer cladding wall of the link.

The connection ring can have a plurality of first screw channels distributed uniformly over the circumference, and the joint support ring of the joint body can have a corresponding number of a plurality of second screw channels distributed uniformly over the circumference, the first screw channels and the second screw channels being designed to receive screws for screwing the connection ring to the joint support ring.

A first screw channel can be arranged on the connection ring between two immediately adjacent receiving areas. A second screw channel can be arranged on the joint support ring between two immediately adjacent engagement elements or claws. The number of first screw channels and the number of second screw channels can correspond to the number of receiving areas and engagement elements or claws.

The object is also achieved by a robot arm, comprising a plurality of links, of which at least one link has a circular cylindrical outer cladding wall, and a plurality of joints which connect the links in a mutually adjustable manner, of which at least one joint has a joint body having a joint support ring, the at least one link having the circular cylindrical outer cladding wall being connected to the at least one joint body by means of a connection device according to at least one of the described embodiments.

Aspects of the invention are explained again below, sometimes expressed differently.

The invention provides a stable, reliable and resilient connection point which is intended to make it possible, for example, to detachably connect a modular joint unit, i.e., a joint body, having a joint support ring, for example a plastics material joint support, to a structural part, i.e., a link of the robot arm, preferably consisting of a tubular profile or semi-finished product, by means of a connection ring, for example a plastics material flange.

For even more flexible and individualized, in particular modular, construction, one or more components of the connection device can be made of plastics material components; in particular, the connection points can also be custom-made, for example, using additive manufacturing.

The advantages lie in the homogeneous distribution, over the largest possible area, of the local and multidimensional load at the connection point, as well as a possibly direct and rectilinear force transmission between the two connecting parts.

The connection device connects, for example, the three parts: tubular profile or link, flange ring or connection ring, and joint support or joint body with joint support ring, in such a way that the tubular profile and the flange ring have a permanent connection and together form the structural part, which is detachably connected to the joint support. This allows for a fast and cost-effective construction, and, most importantly, a very flexible one, as the structural length can be easily varied via the length of the tube. The detachable interface simplifies the installation of the modules and is used for service tasks and for later reconfiguration of the kinematics.

The connection between the tube and the ring can be created by means of an adhesive bond in that the ring is slid onto the tube end via its inner circumferential surface, for example, with a transition fit or a light press fit, until it reaches stop elements. Optional longitudinal grooves can ensure a uniform distribution of the adhesive and prevent the adhesive from being displaced when sliding the ring on.

Recesses on the ring can be used, among other things, as shaped elements to temporarily couple a device and to align two adjacent rings of a structural part during installation.

The ring can substantially be constructed from an arrangement of circularly uniformly distributed pockets, which provide different functions with different shaped elements.

The most important shaped element is the contact surface, which is inclined in two spatial directions and has a wedge-shaped configuration via two angles of inclination. The contact surfaces are the two tangential boundaries of the pocket. In the radial direction, the pocket is preferably limited to the outside by a curved segment, which connects the two contact surfaces and can easily transfer and reduce torsional moments and shear stresses between the contact surfaces. The curved segment does not rest on the coupling partner, so no radial forces or tilting moments are transmitted here.

These radial forces and tilting moments, in a total of four spatial directions, are transferred from the joint support directly to the tube on the radial inner side of the pockets, for example in that the ring has recesses which allow the inner side of the tooth to rest directly and guided on the free circumferential surface of the tube. Accordingly, these generally dominant loads, especially with regard to slower service robotics applications and possibly an advantageous flat SCARA design, are predominantly transferred directly to the stable tube without overloading the plastics material ring.

The connection between the ring and the support is made in the axial direction, via axial forces and torsional moments in a total of two spatial directions, by teeth or claws which are designed to fit into the pockets of the ring so that their flanks touch the contact surfaces of the pockets, but the tooth roots and tooth tips have no axial contact with the opposite surfaces. In the axial direction, the ring and the support are preferably drawn together by means of a screw connection, where a screw having a wide head is guided through a through-hole and rests against the flange surface over the largest possible area.

A counter thread can be directly integrated into the tooth, in particular in the tooth tip of the support, for example as a press-in nut, additionally joined or designed as an inserted nut. The latter is illustrated here by way of example. For example, the nut can be inserted into a recess in the tooth from behind to the tooth tip in such a way that it is secured against twisting by shaped surfaces. It is also possible to laterally insert the nut from the outside.

A specific exemplary embodiment of the invention is explained in more detail in the following description with reference to the accompanying figures. Specific features of this embodiment can represent general features of the invention regardless of the specific context in which they are mentioned, optionally also considered individually or in further combinations.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 depicts an exemplary robot arm,

FIG. 2 is a perspective representation of an exemplary inventive connection device in a first view,

FIG. 3 is a perspective representation of an exemplary inventive connection device in a second view,

FIG. 4 is a sectional representation of the connection device according to FIG. 2 and FIG. 3 when disconnected,

FIG. 5 is a sectional representation of the connection device according to FIG. 2 and FIG. 3 when connected,

FIG. 6 is a perspective sectional representation of the connection device according to FIG. 2 and FIG. 3 when connected by screws,

FIG. 7 is an enlarged partial sectional representation of the connection device according to FIG. 6 in the region of a screw,

FIG. 8 is a perspective representation of the connection ring of the connection device according to FIG. 2 and FIG. 3 in isolation from the front,

FIG. 9 is a perspective representation of the connection ring of the connection device according to FIG. 2 and FIG. 3 in isolation from behind,

FIG. 10 is a perspective representation of the connection ring of the connection device according to FIG. 2 and FIG. 3 mounted on a tubular link,

FIG. 11 is a schematic representation of the connection device according to FIG. 2 and FIG. 3 with a partial section in the region of two engagement element/receiving area connections, and

FIG. 12 is a schematic representation of the connection device according to FIG. 2 and FIG. 3 when connected.

### DETAILED DESCRIPTION

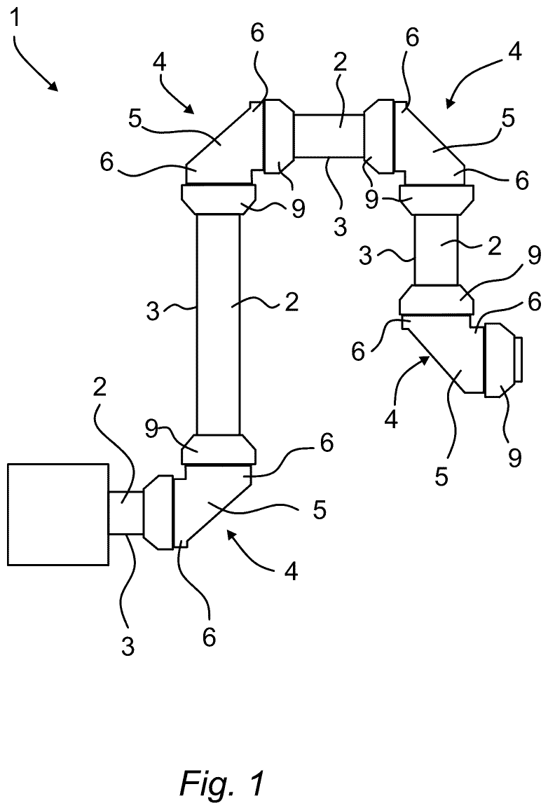

FIG. 1 shows a robot arm 1. The robot arm 1 has a plurality of links 2, of which at least one link 2 has a circular cylindrical outer cladding wall 3. The robot arm 1 also has a plurality of joints 4 which connect the links 2 in a mutually adjustable manner, of which at least one joint 4 has a joint body 5 having a joint support ring 6, the at least one link 2 having the circular cylindrical outer cladding wall 3 being connected to the at least one joint body 5 by means of a connection device 7, as described in more detail below.

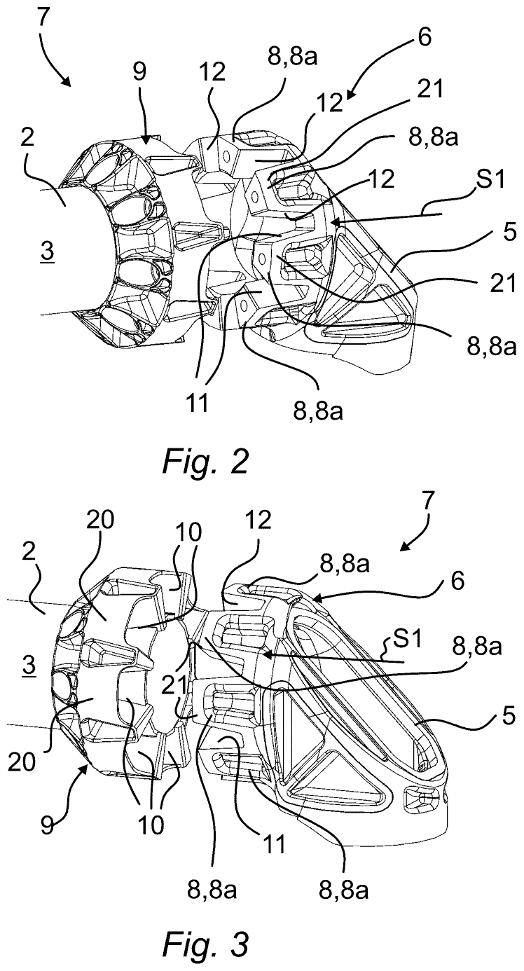

The connection device 7, as shown in particular in FIG. 2 to FIG. 5, serves to connect a link 2 of the robot arm 1 to a joint body 5 of the robot arm 1.

The connection device 7 comprises one of the links 2, which has a circular cylindrical outer cladding wall 3.

The joint body 5 comprises a joint support ring 6, which has a plurality of engagement elements 8 distributed uniformly over the circumference.

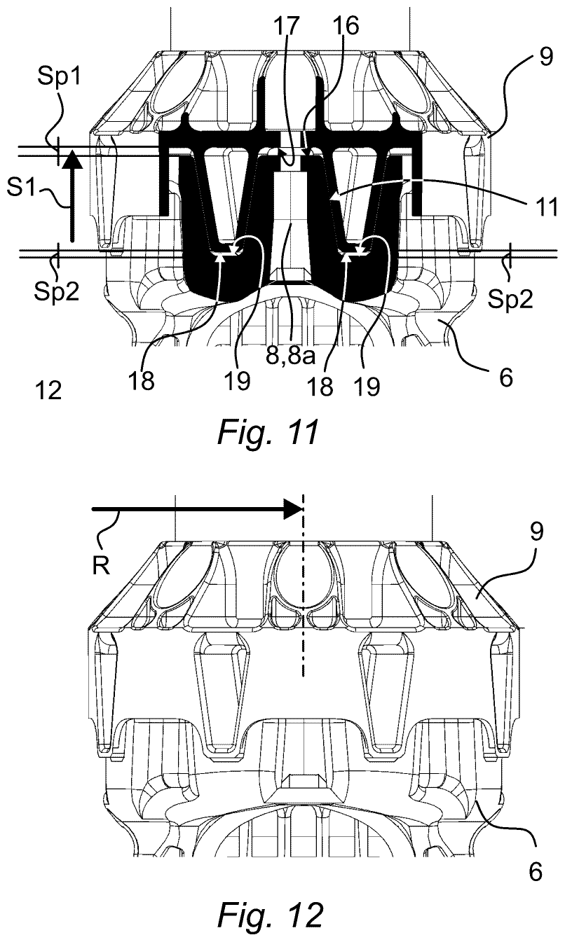

The connection device 7 also comprises a connection ring 9 which is connected to the outer cladding wall 3 of the link 2 and which has a plurality of receiving areas 10 distributed uniformly over the circumference, each receiving area being designed to receive one of the engagement elements 8 of the joint support ring 6 in a form-fitting manner to connect the link 2 to the joint body 5 when the connection ring 9 is connected to the joint support ring 6 in that the engagement elements 8 of the joint support ring 6 engage in the receiving areas 10 of the connection ring 9 in a form-fitting manner, as is shown in particular in FIG. 5 and FIG. 11.

In the case of the present exemplary embodiment, each engagement element 8 of the joint support ring 6 is designed as a claw 8a projecting in the axial insertion direction S1.

The particular claw 8a has a claw front side 11 pointing in the circumferential direction and a claw rear side 12 pointing opposite to the circumferential direction, as can be seen in particular in FIG. 2, FIG. 3 and FIG. 11.

The claw front side 11 and the claw rear side 12 are inclined obliquely toward one another in a radially inwardly pointing radial direction R on the one hand and also inclined obliquely toward one another in the axial insertion direction S1 on the other hand.

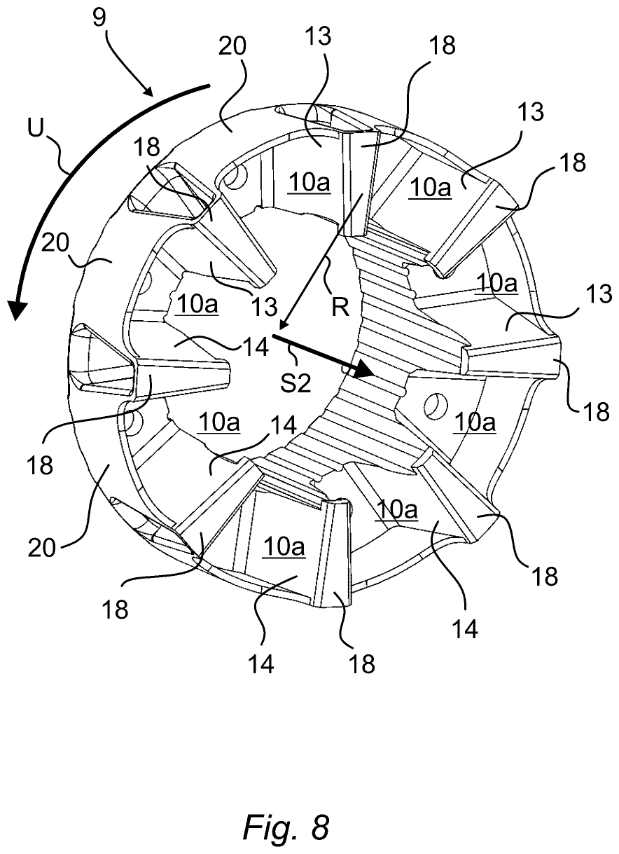

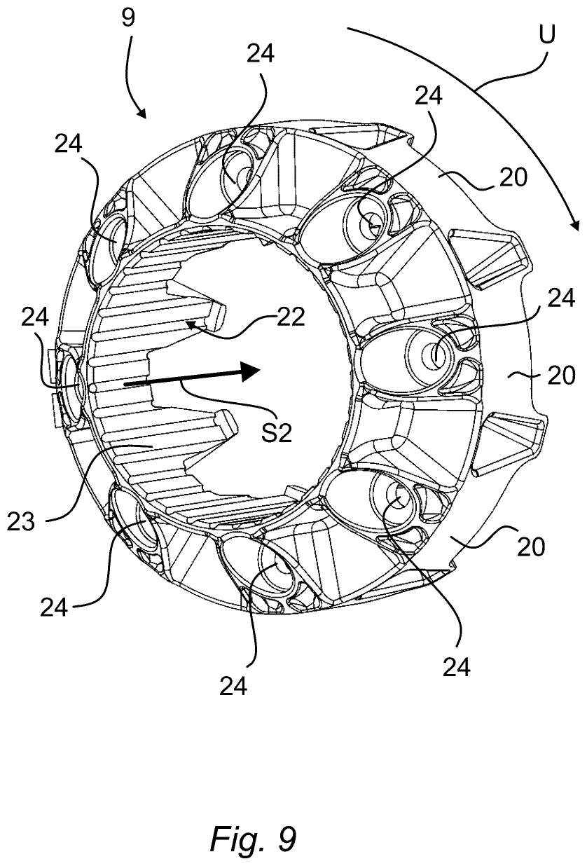

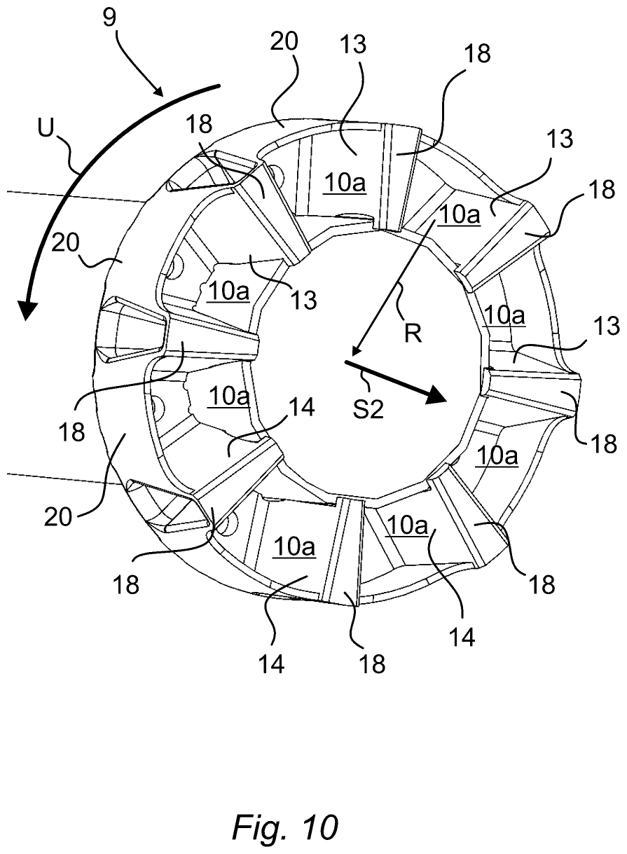

As can be seen in particular in FIG. 8, FIG. 9 and FIG. 10, each receiving area 10 of the connection ring 9 is designed as a pocket 10a corresponding to the claw 8a, which pocket has a pocket front side 13 pointing in the circumferential direction U and a pocket rear side 14 pointing opposite to the circumferential direction U, the pocket front side 13 and the pocket rear side 14 being inclined obliquely toward one another in a radially inwardly pointing radial direction R on the one hand and also being inclined obliquely away from one another in the axial insertion direction S2 on the other hand.

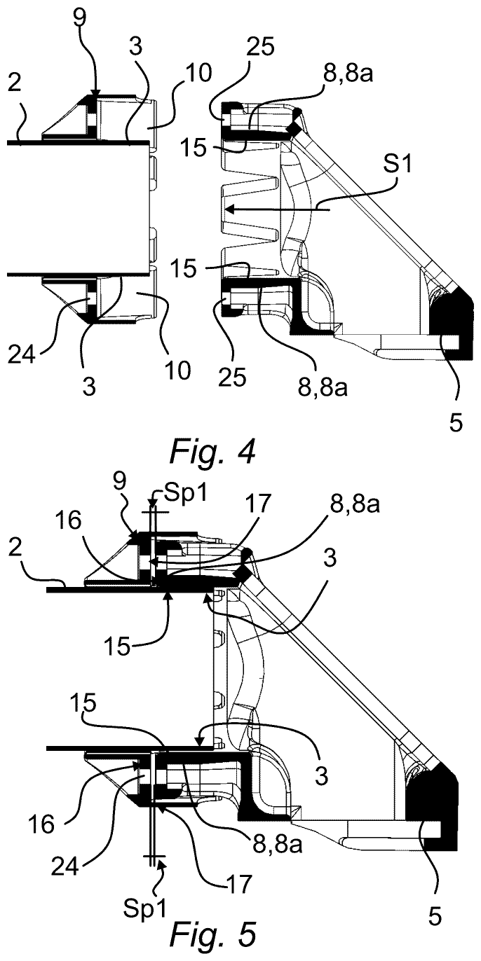

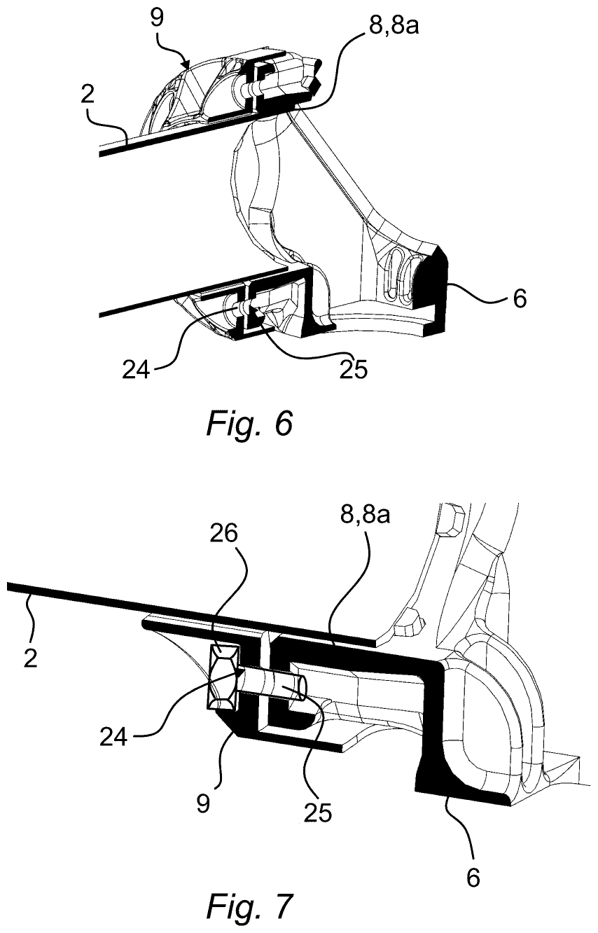

In the case of the present exemplary embodiment, each claw 8a projecting in the axial insertion direction S1 has a claw inner side 15 which is designed such that, when the connection ring 9 is connected to the joint support ring 6, a particular claw inner side 15 of the claw 8a sits precisely on the outer cladding wall 3 of the link 2. This is illustrated in particular in FIG. 4 and FIG. 5.

In the case of the present exemplary embodiment, the engagement elements 8 of the joint support ring 6 engage in the receiving areas 10 of the connection ring 9 in such a way that, when the connection ring 9 is connected to the joint support ring 6, a particular end wall 16 of each engagement element 8 pointing in the insertion direction S1 is positioned at a distance from associated bottom walls 17 of the corresponding receiving areas 10 of the connection ring 9, while leaving a corresponding gap Sp1.

As shown in particular in FIG. 8 and FIG. 10, the engagement elements 8 of the joint support ring 6 can engage in the receiving areas 10 of the connection ring 9 in such a way that, when the connection ring 9 is connected to the joint support ring 6, a particular front edge protrusion 18 pointing in the insertion direction S2, which in each case connects two adjacent receiving areas 10, is positioned at a distance from associated foot walls 19 of the joint support ring 6, which foot walls in each case connect two adjacent engagement elements 8, while leaving a corresponding gap Sp2. This is also illustrated in FIG. 11.

In the case of the present exemplary embodiment, each receiving area 10 has an arcuate, radially outwardly curved receiving area circumferential outer wall 20 and each engagement element 8 has a flat engagement element circumferential outer wall 21 (FIG. 2, FIG. 3), so that when the connection ring 9 is connected to the joint support ring 6, a gap Sp3 is formed between the inner side of each receiving area circumferential outer wall 20 and the corresponding outer side of the relevant engagement element circumferential outer wall 21.

In the case of the present exemplary embodiment, the connection ring 9 is glued onto the circular cylindrical outer cladding wall 3 of the link 2.

As can be seen in particular in FIG. 9, the connection ring 9 can have an inner cladding wall 22 which forms a contact surface with which the connection ring 9 is glued onto the circular cylindrical outer cladding wall 3 of the link 2, the inner cladding wall 22 being provided with longitudinal grooves 23 which form distribution channels for an adhesive by means of which the connection ring 9 is glued onto the circular cylindrical outer cladding wall 3 of the link 2.

In the case of the present exemplary embodiment, the connection ring 9 has a plurality of first screw channels 24 (FIG. 9) distributed uniformly over the circumference, and the joint support ring 6 of the joint body 5 has a corresponding number of second screw channels 25 distributed uniformly over the circumference, the first screw channels 24 and the second screw channels 25 being designed to receive screws 26 for screwing the connection ring 9 to the joint support ring 6.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

What is claimed is:

1. A connection device for connecting a link (2) of a robot arm (1) to a joint body (5) of the robot arm (1), comprising:
a link (2) having a circular cylindrical outer cladding wall (3),
a joint body (5) having a joint support ring (6) which has a plurality of engagement elements (8) distributed uniformly over the circumference, and
a connection ring (9) which is connected to the outer cladding wall (3) of the link (2) and which has a plurality of receiving areas (10) distributed uniformly over the circumference, each receiving area being designed to receive one of the engagement elements (8) of the joint support ring (6) in a form-fitting manner to connect the link (2) to the joint body (5) when the connection ring (9) is connected to the joint support ring (6) in that the engagement elements (8) of the joint support ring (6) engage in the receiving areas (10) of the connection ring (9) in a form-fitting manner.

2-10. (canceled)

11. The connection device according to claim 1, characterized in that each engagement element (8) of the joint support ring (6) is designed as a claw (8a) projecting in the axial insertion direction (S1), which claw has a claw front side (11) pointing in the circumferential direction (U) and a claw rear side (12) pointing opposite to the circumferential direction (U), the claw front side (11) and the claw rear side (12) being inclined obliquely toward one another in a radially inwardly pointing radial direction (R) on the one hand and also being inclined obliquely toward one another in the axial insertion direction (S1) on the other hand, and each receiving area (10) of the connection ring (9) being designed as a pocket (10a) corresponding to the claw (8a), which pocket has a pocket front side (13) pointing in the circumferential direction (U) and a pocket rear side (14) pointing opposite to the circumferential direction (U), the pocket front side (13) and the pocket rear side (14) being inclined obliquely toward one another in a radially inwardly pointing radial direction (R) on the one hand and also being inclined obliquely away from one another in the axial insertion direction (S2) on the other hand.

12. The connection device according to claim 11, characterized in that each claw (8a) projecting in the axial insertion direction (S1) has a claw inner side (15) which is designed such that, when the connection ring (9) is connected to the joint support ring (6), a particular claw inner side (15) of the claw (8a) sits precisely on the outer cladding wall (3) of the link (2).

13. The connection device according to claim 1, characterized in that the engagement elements (8) of the joint support ring (6) engage in the receiving areas (10) of the connection ring (9) in such a way that, when the connection ring (9) is connected to the joint support ring (6), a particular end wall (16) of each engagement element (8) pointing in the insertion direction (S1) is positioned at a distance from associated bottom walls (17) of the corresponding receiving areas (10) of the connection ring (9), while leaving a corresponding gap (Sp1).

14. The connection device according to claim 1, characterized in that the engagement elements (8) of the joint support ring (6) engage in the receiving areas (10) of the connection ring (9) in such a way that, when the connection ring (9) is connected to the joint support ring (6), a particular front edge protrusion (18) pointing in the insertion direction (S2), which in each case connects two adjacent receiving areas (10), is positioned at a distance from associated foot walls (19) of the joint support ring (6), which foot walls in each case connect two adjacent engagement elements (8), while leaving a corresponding gap (Sp2).

15. The connection device according to claim 1, characterized in that each receiving area (10) has an arcuate, radially outwardly curved receiving area circumferential outer wall (20) and each engagement element (8) has a flat engagement element circumferential outer wall (21), so that when the connection ring (9) is connected to the joint support ring (6), a gap (Sp3) is formed between the inner side of each receiving area circumferential outer wall (20) and the corresponding outer side of the relevant engagement element circumferential outer wall (21).

16. The connection device according to claim 1, characterized in that the connection ring (9) is glued onto the circular cylindrical outer cladding wall (3) of the link (2).

17. The connection device according to claim 16, characterized in that the connection ring (9) has an inner cladding wall (22) which forms a contact surface with which the connection ring (9) is glued onto the circular cylindrical outer cladding wall (3) of the link (2), the inner cladding wall (22) being provided with longitudinal grooves (23) which form distribution channels for an adhesive by means of which the connection ring (9) is glued onto the circular cylindrical outer cladding wall (3) of the link (2).

18. The connection device according to claim 1, characterized in that the connection ring (9) has a plurality of first screw channels (24) distributed uniformly over the circumference, and the joint support ring (6) of the joint body (5) has a corresponding number of a plurality of second screw channels (25) distributed uniformly over the circumference, the first screw channels (24) and the second screw channels (25) being designed to receive screws (26) for screwing the connection ring (9) to the joint support ring (6).

19. A robot arm, comprising a plurality of links (2), of which at least one link (2) has a circular cylindrical outer cladding wall (3), and a plurality of joints (4) which connect the links (2) in a mutually adjustable manner, of which at least one joint (4) has a joint body (5) having a joint support ring (6), the at least one link (2) having the circular cylindrical outer cladding wall (3) being connected to the at least one joint body (5) by means of a connection device (7) according to claim 1.
